(19) United States
(12) Patent Application Publication
(10) Pub. No.: US 2007/0175698 A1
(43) Pub. Date: Aug. 2, 2007

(54) Mechanism for arresting the fall of a weighted entity, and for initiating and managing a controlled descent

(76) Inventor: Thomas Dale Ketring, Youngsville, NC (US)

Correspondence Address: Raleigh Rockyard, Inc., Suite 143, 4200 Atlantic Avenue, Raleigh, NC, 27604, US

(21) Appl. No.: 11/657,511

(22) Filed: Jan. 24, 2007

Related U.S. Application Data
(60) Provisional application No. 60/763,432, filed on Jan. 30, 2006.

(51) Int. Cl. A62B 1/16

(52) U.S. Cl. 182/8

(57) ABSTRACT

The invention is a device capable of providing fall protection for a climber, which enables the climber to remain suspended after a fall, or to descend in a controlled manner. The device utilizes a safety line, which is governed by a novel combination of: a mechanism which applies a continuous level of resistance to the safety line, and a variable force which pulls on the safety line in the opposite direction of a climber's descent during a fall. Together, these two forces serve to hinder the free travel of the safety line in the direction of a fall. The variable opposing force, when fully applied to the safety line, combines with the continuously applied resistance to arrest the climber's fall. However, when this opposing force is applied to a lesser degree, the combination of resistance applied against the safety line is not sufficient to suspend the climber, and the climber can descend. The variable opposing force is applied in full by default, but can be removed in part or whole by the climber via a separate mechanism, which is not affected by the continuously applied resistance, and is therefore easily controlled by the climber.

This application claims the benefit of Provisional patent No. 60/763,432, filing date Jan. 30, 2006.

Referenced Patents

| | | |
|---|---|---|
| 6241045 | Reeve, et al. | Jun. 5, 2001 |
| 4991064 | Motte, et al. | Mar. 5, 1991 |
| 4941548 | Blanchard | Jul. 17, 1990 |
| 4589523 | Olsen, et al. | May 20, 1986 |
| 4458781 | Ellis, et al. | Jul. 10, 1984 |
| 4252214 | Miller | Feb. 24, 1981 |
| 3946989 | Tsuda | Mar. 30, 1976 |
| 3908791 | Kleine, et al. | Sep. 30, 1975 |
| 3826335 | Allen | Jul. 30, 1974 |
| 3467224 | Curtis, et al. | Sep. 16, 1969 |

### BACKGROUND OF THE INVENTION

In order to climb a wall, scaffolding, or edifice safely, one must employ some means of fall protection. Historically, fall protection has often been provided by another individual acting as a belayer, using a safety rope threaded through a friction providing device to assist the belayer in arresting the climber's fall. In this arrangement, as the climber ascends, the belayer removes accumulated slack from the rope, and then holds the rope firmly against the friction providing device. The friction provided by the device, and the force applied by the belayer, combines to provide a measure of resistance which is sufficient to arrest the climber's fall.

Further, in this arrangement, the belayer can allow the climber to descend at a safe rate of speed by lessening the amount of force he uses to hold the rope against the friction providing device. As a result, the amount of resistance provided by the friction providing device is no longer sufficient to suspend the climber, and the climber descends.

When a second person is not available, however, a climber must rely on automated means to provide protection from a fall. Prior automated devices for fall protection have used a number of complex mechanical processes to slow or stop a climber's undesired descent.

In a device described in U.S. Pat. No. 4,538,703, a centrifugally-actuated clutch coupling the pulley to a speed-multiplying gearing system and a centrifugally-operated braking assembly engages to slow the rate of the climber's descent after his descent has exceeded a speed predetermined to be safe.

In a device described in U.S. Pat. No. 4,550,804, a similarly complex mechanism is explained in which a safety line extends from the climber overhead and through a sheave keyed to a motor drive shaft which is free wheeling in one direction of rotation in response to advancement of the cable as the workman is climbing but will impose a controlled resistance in the opposite direction, this resistance being established through a hydraulic motor for the drive shaft and a hydraulic control circuit which includes a flow controller to resist the rotation of the motor in the opposite direction.

In a device described in U.S. Pat. No. 4,458,781, the climber is attached to a cable which extends overhead and through a ratchet and pawl style device with a brake shoe which activates when the climber weights the cable in a manner consistent with a fall.

In many of the devices that make up the body of prior art in this field, a counterweight is used to eliminate slack in the safety rope. Counterweight alone, however, is problematic as a fall arrest device, because if the weight is less than that of the climber, the climber's speed will continue to increase as he descends.

Also, as described above, a vital element of these devices is a braking mechanism actuated by either the direction in which the safety line is travelling, or the speed at which the line is paying out toward the climber during descent. In general, these devices do not effectively allow the climber to remain suspended at will and descend when desired. They are also complicated, and require a great deal of maintenance in order to remain reliable.

### SUMMARY OF INVENTION

It is an object of this invention to provide a fall arrest device which does not rely upon complicated hydraulic or speed sensitive mechanisms, and one which will arrest the climbers fall, and allow the climber to remain suspended, or descend in part or in whole, as desired. It is a further object of this invention to provide a fall protection device which is automatically adapted to a wide range of climber's weights, and is simple to operate by minimally skilled individuals.

One novelty of the invention lies in an alternative approach to manipulating the total resistance needed to arrest a climber's fall. As discussed above, prior devices have relied first upon a dual action mechanism, which offers relatively free movement of a climber's safety line in one direction, but which restricts movement of that line in the opposite direction, or in the opposite direction and above a predetermined speed. Secondly, a separate and less significant opposing force, often supplied by a counterweight, is applied constantly to the safety line merely to remove slack.

However, this new invention uses a different application of forces to achieve the same goals, and further goals. First, instead of using a dual action mechanism, which performs differently in different situations, the new invention uses a fixed mechanism to provide a constant friction, or resistance, to the safety line, regardless of the direction or speed of the safety rope's movement. Second, instead of using a counterweight, or similar force, in a constant application merely to remove slack from the safety line, the invention employs both a counterweight or opposing force, and also a means to vary the weight of the counterweight, or the amount of opposing force, which ultimately manipulates the total resistance applied to the safety line.

If the counterweight, or similar opposing force, is applied against the safety line in full measure, the resulting combination of both the first, fixed application of resistance, and the second, variable opposing force of a counterweight or similar application of force, is sufficient to arrest a climber's fall.

If, however, the counterweight, or similar opposing force, is applied against the safety line to a lesser degree, then the resulting combination of both the first, fixed application of resistance, and the second, variable opposing force of a counterweight, or similar application of force, falls below the level which is sufficient to arrest a climber's fall, and the climber subsequently descends.

An equally novel aspect of the invention pertains to the method by which the impact of the counterweight, or other opposing force, is increased or decreased. The invention employs a separate line, or control cord, which is attached at one end to the counterweight, or other opposing force, and which extends along a similar path as is followed by the safety line, and further extends to within reach of the climber. This control cord is, however, routed around the first mechanism, which applies a fixed amount of resistance to the safety line. As a result, considerably less total resistance can ever be applied to the control cord.

By pulling on this control cord, the climber can easily lessen the impact of the counterweight, or other opposing force, to such a degree that the amount of resistance it supplies to the safety line, when combined with the first mechanism, which applies fixed resistance, is not sufficient to suspend the climber, and the climber can descend.

Further, the climber can, by pulling harder or more gently on the control cord, descend as quickly or slowly as desired, or, by releasing the control cord, cease descending, and remain suspended again. If at any time, the climber resumes ascending, the invention is always in a ready state to resume removing slack and provide fall protection.

It is easy to conceive of subtle variations of the above described invention which would adapt to a variety of tasks. For example, although the invention is quite well suited for arresting the fall of a climber, it is also well suited as an emergency escape device from multi story buildings or the like. Similarly, the device would afford an individual a greater control while handling heavy loads.

It is also possible to conceive of variations in the arrangement of elements that comprise the invention, while not materially changing the core concept that makes the invention unique. For example, any means that reduces or eliminates the force supplied by the counterweight or other opposing force is, nevertheless, following the order dictated by the above descriptions, in the same manner as does the control cord. Therefore, any processes involving mechanical winches or hydraulic mechanisms in this effort offer merely a more complex variation of the same essential solution.

Further, it is readily obvious that any means employed to apply an opposing force, as is applied by the described counterweight, is consistent with the above description of the invention. Therefore, a mechanism which involves springs or tensioning devices, or which winds the accumulating slack around a rotating drum or other similar device, is merely a more complex variation of the same essential solution.

It is a clear advantage of the described invention that it provides superior performance, without relying upon more complicated mechanisms or processes which would require a higher degree of maintenance and supervision.

The following drawings illustrate one embodiment of the invention, and are descriptive of a consistent application of the key elements of the invention for the purpose of clarity. It is to be expressly understood, however, that each of the figures is provided for the purpose of illustration and description only and is not intended as a definition of the limits of the present invention.

### BRIEF DESCRIPTION OF DRAWINGS

FIG. 1 is a depiction of a climber ascending a climbing structure, with the invention providing fall protection.

FIG. 2 is a depiction of the climber as he initially falls, and of the invention as it arrests the climber's fall.

FIG. 3 is a depiction of the climber pulling upon the control cord to initiate his descent.

FIG. 4 is a cross section detailing the enclosure and its contents, and further detailing the mechanism which applies a fixed resistance against the safety line, said resistance serving to inhibit, yet not fully prevent, the free movement of the safety line through the mechanism.

### DETAILED DESCRIPTION OF DRAWINGS

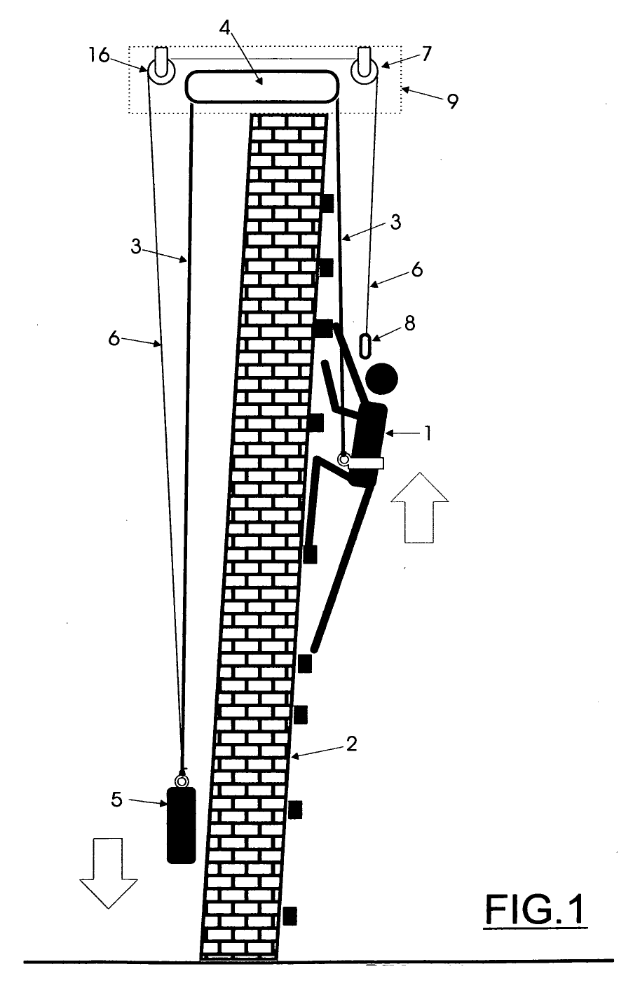

In the invention illustrated in FIG. 1, A safety line 3 is attached to climber 1, extends overhead, passes through the friction providing mechanism 4, and further extends downward to ultimately attach to the opposing force 5. As the climber 1 ascends the climbing structure 2, the amount of force he imparts upon the safety line 3 is reduced nearly to zero, and the amount of friction applied to the safety line 3 by the described mechanism 4 is no longer sufficient to resist the opposing force 5, and the described opposing force 5 causes the accumulated slack in safety line 3 to be removed. Specifically, in the embodiment illustrated in FIG. 1, a counterweight acts as the opposing force 5, and as it descends, it removes the accumulated slack in the safety line 3.

Also attached to opposing force 5 is the control cord 6, which follows a similar path as the safety line 3, but which is diverted around the friction providing mechanism 4, by means of low-friction pulley 7 and low-friction pulley 16. The control cord 6 extends to within reach of the climber 1, and attaches to a suitable handle 8.

As the counterweight 5 descends, removing slack from safety line 3, the control cord 6 travels freely across the pulleys 7 and 16, and the handle 8 ascends in concert with the climber 1, and is thereby always within reach.

An enclosure 9 surrounds the collective components of the invention: the friction providing mechanism 4, pulley 7, and pulley 16. The safety line 3, and the control cord 6, pass through the enclosure 9 as they interact with the friction providing mechanism 4, and the pulleys 7 and 16.

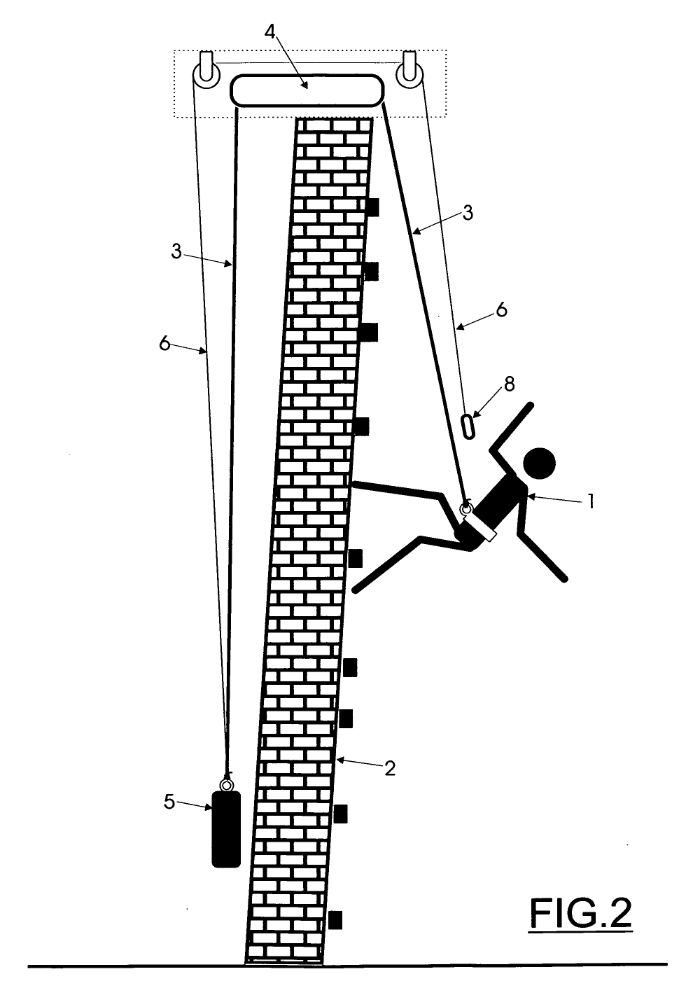

In the invention illustrated in FIG. 2, the climber 1 initiates a fall from climbing structure 2. The climber's 1 weight impacts safety line 3, which pulls against the opposing force 5. However, the combination of resistance between opposing force 5 and the friction providing mechanism 4 is sufficient to arrest the climber's 1 fall, and the climber 1 is suspended. Also shown is control cord 6, extending from the opposing force 5 to within reach of climber 1. Handle 8, as of yet unused by the climber 1, is nevertheless available when the climber 1 wishes to descend.

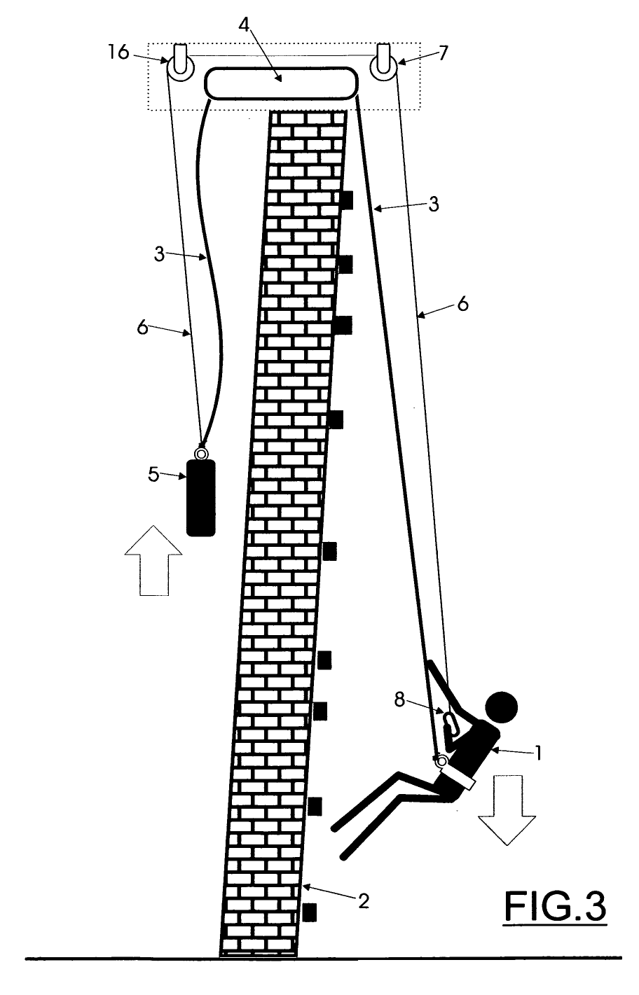

In the invention illustrated in FIG. 3, the climber has initiated his descent. The climber 1 grasps handle 8, and pulls it, and the control cord 6, toward him. The control cord 6 passes freely along pulley 7 and pulley 16, and easily overwhelms the opposing force 5. Specifically in the illustrated example, the climber's 1 energy, exerted against control cord 6, is sufficient to lift the counterweight serving as the opposing force 5.

The mitigation of opposing force 5 causes a buildup of slack in safety line 3. As a result, the combined resistance of opposing force 5 and friction providing mechanism 4 are no longer sufficient to suspend the climber 1, and the climber begins to descend. As the climber 1 descends, his continued grasp of handle 8 maintains the force against control cord 6, and in turn, continues to mitigate opposing force 5; thus, the descent continues smoothly until such time as the climber releases handle 8. At such time, the force along control cord 6 is released, and no longer impacts the opposing force 5. Therefore, the combined resistance of opposing force 5 and the friction providing mechanism 4 are again sufficient to suspend the climber 1, and the climber's 1 descent halts.

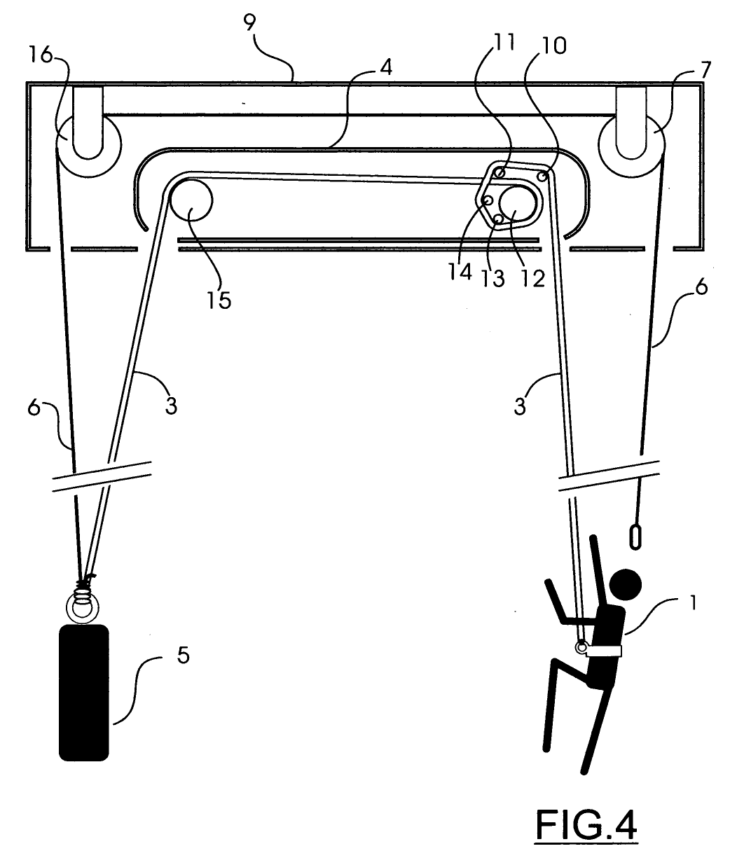

FIG. 4 illustrates a cross section of the enclosure 9, which contains pulley 7 and pulley 16, and friction providing mechanism 4, which is further detailed. As illustrated, the safety line 3, which extends from the climber 1, enters the enclosure 9, and then enters the friction providing mechanism 4. The safety line 3 passes along and against fixed shaft 10, fixed shaft 11, fixed shaft 14, fixed shaft 13, fixed shaft 12, and then on to fixed shaft 15. The safety line 3 then exits enclosure 9 and extends onward to attach to opposing force 5.

Also illustrated in FIG. 4, control cord 6 extends from within climber's 1 reach, enters the enclosure 9, passes across pulley 7, passes across pulley 16, and then exits the enclosure 9, ultimately attaching to the opposing force 5.

What is claimed is:

1. A device for protecting an ascending entity from undesired descent, which consists of:
(1) A safety rope, cord or cable (safety line) one end of which is attached to the ascending entity, and which extends overhead, through a secure anchor point, and beyond.
(2) An opposing force attached to the opposite end of said safety line, which serves to keep the safety line snug as the entity ascends; but which is not a sufficient force to arrest the entity's descent alone.
(3) A mechanism which applies a constant measure of resistance to retard the movement of the safety line, in either direction, and to such a degree that, while said resistance alone is not sufficient to arrest the entity's descent, the combination of said resistance and said opposing force is sufficient to prevent the entity's descent.

2. A device as described in claim 1, which additionally allows the desired descent of said entity by use of a separate mechanism to withdraw and withhold, in part or whole, only the said opposing force from said safety line as long as the entity's descent is desired, while not lessening the resistance provided by the described constant resistance providing mechanism.

3. A device as described in claim 2, in which the described separate mechanism consists of a control cord which is attached to said opposing force on one end, and which extends along a path similar to the said safety line onward to within reach of the ascending entity or an individual responsible for controlling the ascent and descent of said entity, but a path which avoids contact with the described constant resistance providing mechanism; thus, allowing said control cord to travel with very low resistance.

4. A device as described in claim 3, in which one or more pulleys serve to re-direct said control cord and guide it into position within reach of the ascending entity or an individual responsible for controlling the ascent and descent of said entity, while contributing very little resistance against the movement of said control cord.

5. A device as described in claim 4, in which said constant resistance providing mechanism is comprised of a fixed member or group of fixed members around which said safety line wraps one or more times.

6. A device as described in claim 4, in which said constant resistance providing mechanism is a fixed member or group of members which form a channel, hole, or groove large enough to accept the said safety line, yet narrow enough to apply the described constant measure of resistance to said safety line.

7. A device as described in claim 4, in which said constant resistance providing mechanism is a pulley or group of pulleys across which the said safety line travels, and which apply the described measure of constant resistance to said safety line.

8. A device as described in claim 4, in which said secure anchor point, said constant resistance providing mechanism, and said pulleys are housed together within a single enclosure, through which said safety line and said control cord travel.
